(19) United States
(12) Patent Application Publication
(10) Pub. No.: US 2008/0314952 A1
(43) Pub. Date: Dec. 25, 2008

(54) Driving Piston Maintaining Structure in Gas Nailer

(76) Inventors: Junichi Tamura, Tokyo (JP); Hajime Takemura, Tokyo (JP); Katsuhiko Murayama, Tokyo (JP)

Correspondence Address: DRINKER BIDDLE & REATH (DC), 1500 K STREET, N.W., SUITE 1100, WASHINGTON, DC, 20005-1209, US

(21) Appl. No.: 12/280,409

(22) PCT Filed: Feb. 20, 2007
(86) PCT No.: PCT/JP2007/053107

§ 371 Date: Aug. 22, 2008

(30) Foreign Application Priority Data
Feb. 23, 2006 (JP) 2006-047258

(51) Int. Cl. B25C 1/14

(52) U.S. Cl. 227/10

(57) ABSTRACT

A gas nailer is provided with a driving cylinder 7, a driving piston 10, a combustion chamber 8, a gas fuel cartridge 2, and a supercharging device 3. The driving piston 10 is operated in the driving cylinder 7 by a combustion pressure generated when a mixture of gas fuel and air is burned in the combustion chamber 8, and a driver hammers a fastener by an operation of the driving piston. A locking device 15 for locking the driving piston 10 is provided in the driving cylinder 7 so as not to move the driving piston 10 in accordance with a pressure increase in the combustion chamber 8 during a supercharging operation in which compressed air is supplied by the supercharging device 3.

### TECHNICAL FIELD

The present invention relates to a gas nailer as an internal combustion type tool for hammering a fastener such as a nail or a hammered screw, and more particularly, to a structure for maintaining a driving piston of the gas nailer which prevents the driving piston from moving in accordance with a pressure increase in a combustion chamber during a supercharging operation.

### BACKGROUND ART

Conventionally, there is known an internal combustion type tool (gas nailer) for hammering a faster, such as a nail or a screw, having a supercharging device for improving a driving force. In the known internal combustion type tool for hammering the fastener, in order to start hammering the fastener, an operation member is operated in response to a pressing action of a front end of the tool to a workpiece. Subsequently, a driving piston of a fuel storage chamber of the supercharging device is operated by an action of the operation member. Subsequently, pressurized supercharged fuel is supplied from the supercharging device to a combustion chamber so as to increase combustion energy, thereby improving the driving force for hammering the fastener by operating of a main driving piston (for instance, US-A-2005/0001002).

In the internal combustion type tool for hammering the fastener such as the nail or the screw (gas nailer) in which an output power is increased by supercharging operation, when the pressurized fuel is supplied to the combustion chamber, the pressure in the combustion chamber is increased and the pressure directly effects the driving piston so that the driving piston located at a predetermined position as an initial movement position moves downward. When the driving piston is pressed to move downward, a problem arises in that a stroke loss of the driving piston occurs and the supercharging effect itself reduces because the pressure increase in the combustion chamber is substantially disturbed. In some cases, the supercharging operation cannot be carried out.

Then, in the known internal combustion type tool for hammering the fastener having the supercharging device, there is not provided a particular countermeasure for solving the above-described problem. Incidentally, as a countermeasure for solving the above-described problem occurring in the known internal combustion type tool for hammering the fastener having the supercharging device, for instance, it may be supposed that a locking device is provided in the driving piston so that the driving piston is prevented from moving downward during the supercharging operation by locking the driving piston in terms of a brake effect.

However, it is difficult to set an adequate locking load for braking the driving piston when realizing the driving piston locking device in terms of the brake effect. As a result, a problem arises in that it is difficult to carry out a return operation in which the driving piston moves upward by using a specific negative pressure occurring in the internal combustion type tool for performing the hammering when the large locking load is set and it is not possible to sufficiently prevent the driving piston from moving downward when the small locking load is set. Then, in order to solve the above-described problems occurring in the supercharging operation, the driving piston locking device has to have a function for adjusting the particular locking load. However, such a driving piston locking device having a function for appropriately adjusting the locking load has not been developed so far.

### DISCLOSURE OF THE INVENTION

The present invention provide a countermeasure for preventing a driving piston from moving downward during a supercharging operation in a gas nailer having a supercharging device. More specifically, a structure for maintaining a driving piston is provided so as to prevent the driving piston from moving in accordance with a pressure increase in a combustion chamber during a supercharging operation by providing a particular locking load adjusting mechanism to the driving piston locking device.

According to one or more embodiments of the invention, in a first aspect of the invention, a gas nailer is provided with: a driving cylinder; a driving piston which slidably reciprocates in the driving cylinder; a combustion chamber which is connected to an upper portion of the driving cylinder; a gas fuel cartridge which supplies gas fuel to the combustion chamber; and a supercharging device which supplies compressed air to supercharged into the combustion chamber. The driving piston is operated in the driving cylinder by a combustion pressure in the combustion chamber upon burning the mixture of the air and the gas fuel, and a driver hammers a fastener in accordance with the operation of the driving piston. A locking device for locking the driving piston is provided in the driving cylinder so that the driving piston is prevented from moving in accordance with the pressure increase in the combustion chamber due to a supercharging operation in which the supercharging device supplies the compressed air to the combustion chamber.

In the second aspect of the invention, the locking device may be locked to a small-diameter portion formed in the driving piston.

In the third aspect of the invention, the locking device may include a movable portion which is provided in an upper portion of the driving cylinder so as to be movable in parallel to a driving direction of the driving piston, and the locking device may engage with or disengages from the driving piston by the movable portion.

In the fourth aspect of the invention, the locking device may be operable to perform a locking action or an unlocking action by magnetizing or demagnetizing a solenoid.

According to the first aspect of the invention, since the locking device is provided so as to prevent the driving piston from moving, even when the pressure increase occurs in the combustion chamber during the supercharging operation in which the supercharging device supplies the compressed air to the combustion chamber, the driving piston does not move. Accordingly, since the stroke loss of the driving piston due to the movement of the driving piston is prevented, it is possible to prevent the reduction in the supercharging effect. As a result, it is possible to sufficiently take advantage of the combustion energy increased by the supercharging effect and thus to increase the power for hammering the faster.

According to the second aspect of the invention, since the locking force for locking the driving piston reduces in accordance with a decrease in the pressure receiving area of the driving piston, it is possible to miniaturize and simplify the structure for maintaining the driving piston and thus to reduce a cost.

According to the third aspect of the invention, since the locking device is configured such that the movable portion is operated in accordance with the predetermined negative pressure occurring in the driving cylinder so as to release the locking action for locking the driving piston, it is possible to release the locking action for locking the driving piston by using the negative pressure generated by the volume decrease when the gas in the driving cylinder is cooled after discharging the combustion gas. Accordingly, for instance, in the gas nailer which performs the return operation for returning the driving piston by using the negative pressure in the driving cylinder, it is possible to smoothly and surely carry out the return operation for returning the driving piston in a state where the locking action using the locking device is released.

According to the fourth aspect of the invention, since the locking device is configured such that the locking action or the unlocking action is carried out by magnetizing or demagnetizing the solenoid, it is possible to adequately and selectively perform the locking action or the unlocking action of the driving piston and to obtain a good operability for the locking action or the unlocking action.

Other aspects and advantages of the invention will be apparent from the description, and the appended claims.

### BRIEF DESCRIPTION OF THE DRAWINGS

FIG. 1 is a side sectional diagram illustrating a gas nailer according to a first embodiment of the invention.

FIG. 2 is an enlarged side sectional diagram illustrating a main part of a structure for maintaining a driving piston of the gas nailer according to the first embodiment of the invention.

FIG. 3(a) is a diagram illustrating an initial state of a structure for maintaining a driving piston 10 of the gas nailer according to the first embodiment of the invention.

FIG. 3(b) is a diagram illustrating a supercharging state of the structure for maintaining the driving piston 10 of the gas nailer according to the first embodiment of the invention.

FIG. 3(c) is a diagram illustrating a combustion state (unlocking state) of the structure for maintaining the driving piston 10 of the gas nailer according to the first embodiment of the invention.

FIG. 3(d) is a diagram illustrating a driving piston return state of the structure for maintaining the driving piston 10 of the gas nailer according to the first embodiment of the invention.

FIG. 4 is a side sectional diagram illustrating a main part of the gas nailer having the structure for maintaining the driving piston according to a second embodiment of the invention (which corresponds to FIG. 2 according to the first embodiment).

FIG. 5(a) is a diagram illustrating an initial state of the structure for maintaining the driving piston 10 of the gas nailer according to the second embodiment of the invention.

FIG. 5(b) is a diagram illustrating a supercharging state of the structure for maintaining the driving piston 10 of the gas nailer according to the second embodiment of the invention.

FIG. 5(c) is a diagram illustrating a combustion state (unlocking state) of the structure for maintaining the driving piston 10 of the gas nailer according to the second embodiment of the invention.

FIG. 5(d) is a diagram illustrating a driving piston return state of the structure for maintaining the driving piston 10 of the gas nailer according to the second embodiment of the invention.

FIG. 6 is a diagram illustrating the structure for maintaining the driving piston according to a third embodiment of the invention.

### DESCRIPTION OF REFERENCE NUMERALS AND SIGNS

A: GAS NAILER
2: GAS FUEL CARTRIDGE
3: SUPERCHARGING DEVICE
7: DRIVING CYLINDER
8: COMBUSTION CHAMBER
10: DRIVING PISTON
13: CONTACT ARM

### BEST MODE FOR CARRYING OUT THE INVENTION

Hereinafter, exemplary embodiments of the invention will be described with reference to the accompanying drawings.

### First Embodiment

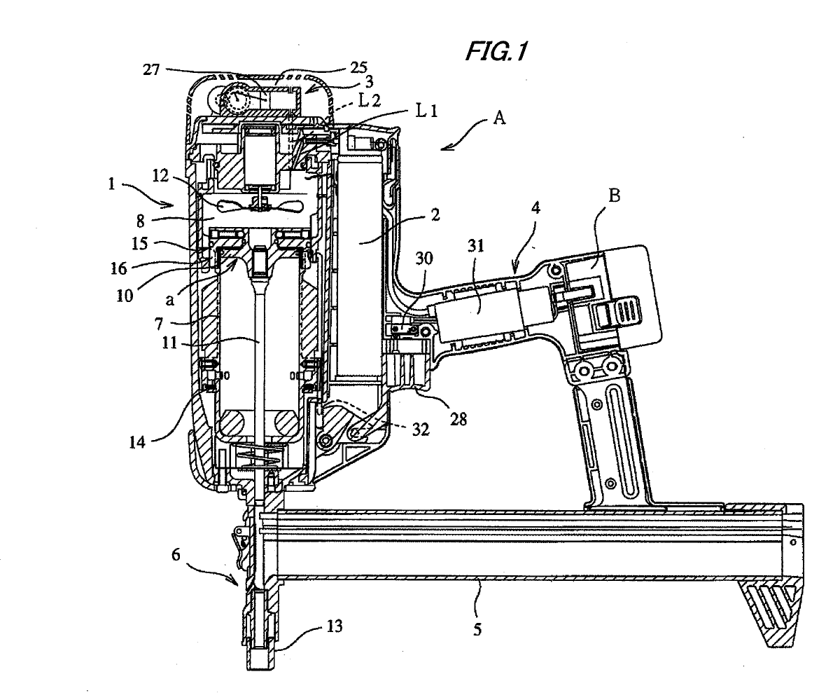

A first embodiment of the invention will be described with reference to FIGS. 1 to 3.

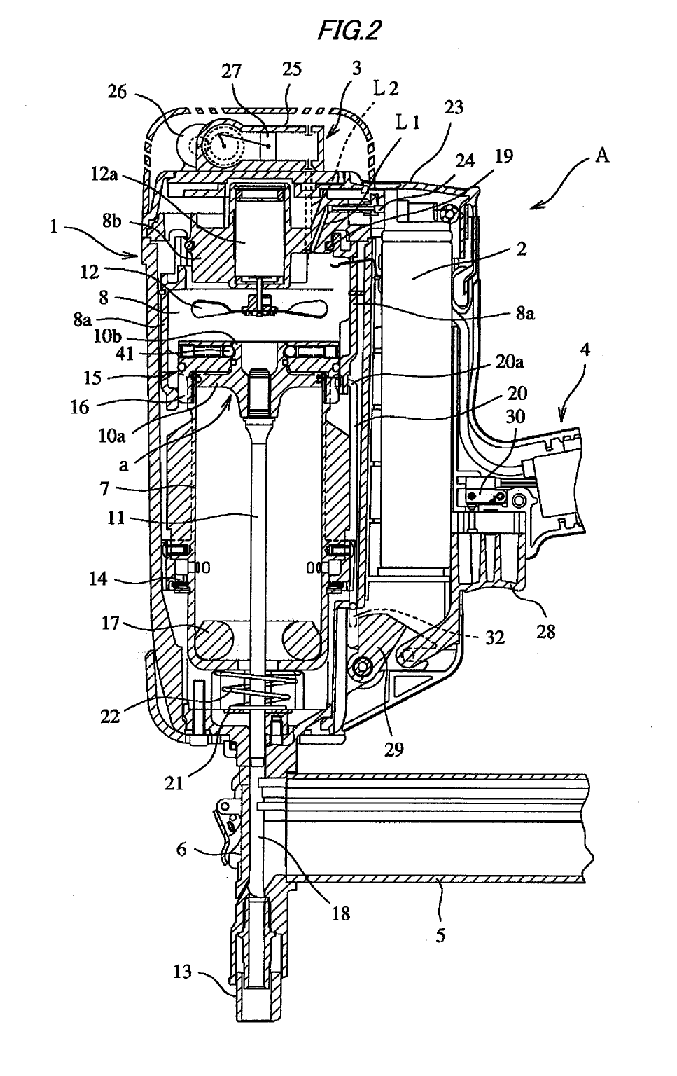

As shown in FIGS. 1 and 2, a gas nailer A according to the invention includes a nailer body 1 which has therein a driving mechanism a, a gas fuel cartridge 2, a supercharging device 3, and the like, a grip 4 which is integrally formed with the nailer body 1, and a nose part 6 which has a magazine portion 5 formed in the lower portion of the nailer body 1 in a protruding manner. In addition, although the nailer is described in the embodiments of the invention, the invention is not limited to the nailer, but may be applied to other tools for hammering other fasteners such as a hammered screw.

Then, the driving mechanism a received in the nailer body 1 includes a driving cylinder 7, a combustion chamber 8 which is disposed above the driving cylinder 7, a driving piston 10 which slidably reciprocates in the driving cylinder 7, a nailer driver 11 of which one base end (upper end shown in the drawing) is fixed to the driving piston 10, a spark plug (not shown) which is mounted to an upper wall of the combustion chamber 8 so that an ignition portion is disposed in the combustion chamber 8, and a stirrer 12 which mixes supplied air and gas fuel with each other. The driving mechanism a further includes a contact arm 13 which performs an initial movement for starting the driving mechanism a. Hereinafter, outlines of the respective structures will be described.

Driving Cylinder

The driving cylinder 7 is configured as a cylindrical member which is disposed at the substantial center of the nailer body 1 and which extends in a vertical direction shown in the drawing so as to have predetermined diameter and thickness. The driving piston 10 integrally fixed to the nailer driver 11 is fitted to the driving cylinder 7 so as to slidably reciprocate therein. In addition, an exhaust port 14 is provided in a lower side portion of the driving cylinder 7 so as to discharge expanded combustion gas to the outside by opening its port at BDC (bottom dead center) of the driving piston 10 used for a nail driving operation.

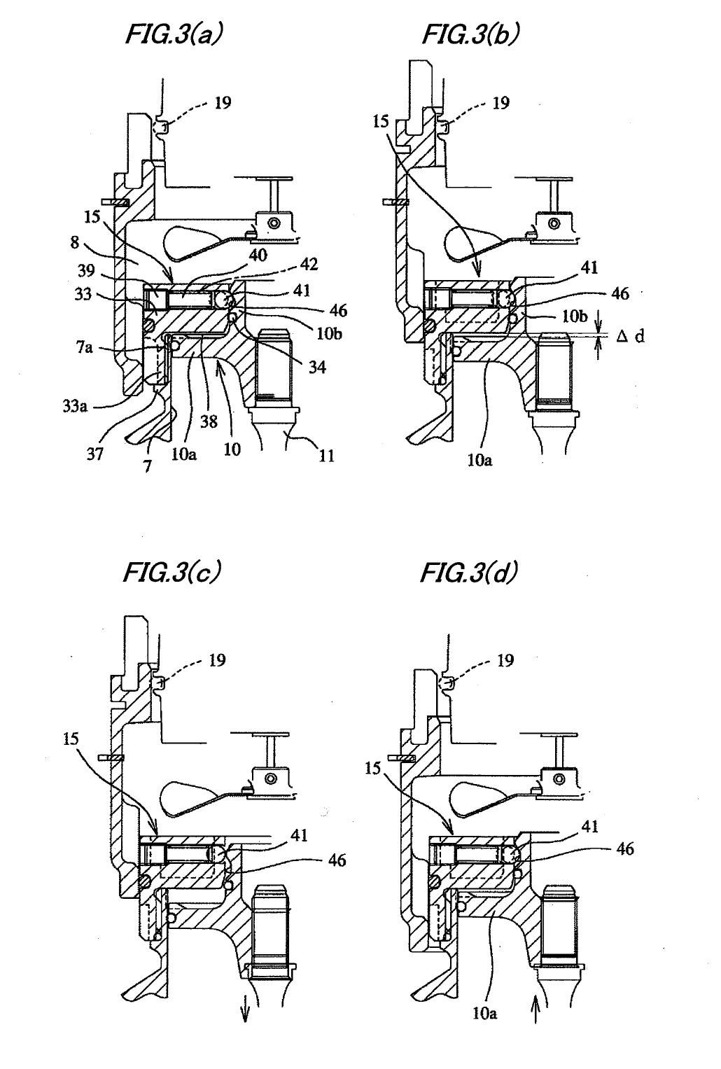

As shown in FIG. 3(a), the upper portion of the driving cylinder 7 configured as the cylindrical member is closely fitted to a lower extending portion 16 of the locking device 15 in a substantially fixed state, the locking device 15 being disposed in the outer periphery of the upper portion of the driving cylinder 7 so as to maintain the driving piston 10 upon being located at TDC (top dead center). In addition, the outer periphery of the lower extending portion 16 of the locking device 15 is slidably close-connected to the lower portion of the annular peripheral wall of the combustion chamber 8. Accordingly, the annular peripheral wall of the combustion chamber 8 is configured to relatively move upward or downward with respect to the outer periphery of the upper portion of the driving cylinder 7 while having an indirect close relationship through the locking device 15.

Driving Piston

As shown in the drawing, the driving piston 10 which can slidably reciprocate in the driving cylinder 7 includes a large-diameter piston portion 10a and a small-diameter piston portion 10b which protrudes from the center of the upper portion of the large-diameter piston portion 10a and of which a diameter is small. The outer periphery of the small-diameter piston portion 10b having a small diameter is locked to the inner periphery of a main body of the locking device 15 under a predetermined pressing load. Accordingly, the driving piston 10 is maintained at a predetermined position in the initial movement, that is, TDC so as not to move with respect to the upper portion of the driving cylinder 7 in accordance with a pressure increase in the combustion chamber 8 during the supercharging operation.

In a nail driving operation, the driving piston 10 reciprocates between both TDC and BDC, in which TDC denotes a predetermined position where the driving piston 10 is located at the upper portion of the driving cylinder 7 in a standby state before the initial movement and BDC denotes a contact position where the driving piston 10 comes into contact with a bumper 17. At this time, when the driving piston 10 moves downward so as to perform the nail driving operation, the nail driving operation is carried out in such a manner that the driver 11 hammers a nail supplied from the magazine portion 5 to an injection port 18 of the nose part 6 in accordance with a downward movement of the driving piston 10.

Combustion Chamber

The combustion chamber 8 is formed by an annular wall 8a and an upper wall 8b. As shown in FIG. 3(a), the inner periphery of the lower portion of the annular wall 8a is slidably close-connected the outer periphery of the upper portion of the driving cylinder 7 through the locking device 15. In addition, the upper portion of the annular wall 8a is slidably close-connected to the upper wall 8b as a fixed wall of the combustion chamber 8 through a seal portion 19.

Then, the annular wall 8a moves upward or downward in a manner synchronized with an upward or downward movement of the contact arm 13. When the annular wall 8a moves upward in accordance with the upward movement of the contact arm 13, the annular wall 8a closes the seal portion 19 formed on the upper wall 8b, thereby allowing the combustion chamber 8 to be in a closed state (see the upper portion of the right annular wall 8a shown in FIG. 2). When the annular wall 8a moves downward in accordance with the downward movement of the contact arm 13, the annular wall 8a opens the seal portion 19, thereby allowing the combustion chamber 8 to be in an opened state opened to the atmosphere (see the upper portion of the left annular wall 8a shown in FIG. 2). At this time, during the closed state, gas fuel is supplied from the gas fuel cartridge 2 and compressed air is supplied from the supercharging device 3. In addition, the spark plug (not shown) and the stirrer 12 are attached to the upper wall 8b.

Contact Arm

Although the whole shape of the contact arm 13 is not clearly shown in the drawing, the contact arm 13 is connected to a link portion 20 through a connection plate 21. One side of the link portion 20 is partly shown in the drawing, and an upper end 20a is connected to the lower end of the annular wall 8a of the combustion chamber 8.

In a standby state where the nail driving operation is not carried out, the connection plate 21 is urged downward by a conical coil spring 22 in a space just below the lower end surface of the driving cylinder 7, and the lower end of the contact arm 13 is maintained at a lower position where the lower end protrudes from the front end of the nose part 6. In the nail driving operation, the lower end of the contact arm 13 is pressed inward by a target object (not shown) to a position where the lower end does not protrude from the front end of the nose part 6.

An operation in which the lower end of the contact arm 13 is pressed inward corresponds to the initial movement for substantially starting the nail driving operation of the gas nailer A. At this time, when the annular wall 8a moves upward, the combustion chamber 8 becomes a sealed state. Subsequently, a locking state of a trigger 28 is released by a lockout bar 32, and a driving switch (not shown) of the stirrer 12 becomes an ON state. Subsequently, an actuator 23 is operated to press the gas fuel cartridge 2 and to open the gas injection port 24. Subsequently, a driving switch (not shown) of the supercharging device 3 becomes an ON state.

In addition, an operation in which the lower end of the contact arm 13 returns to the lower position corresponds to a return operation which is carried out by the spring 22 upon releasing the operation for pressing inward the contact arm 13. With the return operation, the operations of the respective operation portions described above return to the initial state.

Nailer Portion

As shown in FIGS. 1 and 2, the nose part 6 guides a sliding movement of the driver 11 and includes the injection port 18 to which a nail is supplied from the magazine portion 5.

Gas Fuel Cartridge and Supercharging Device

Then, as clearly shown in FIG. 2, the gas fuel cartridge 2 is vertically disposed in an elongate side space which is formed at a position on the right side of the combustion chamber 8 and the driving cylinder 7 of the nailer body 1 so as to extend in a vertical direction. When the actuator 23 is operated, the gas injection port 24 of the gas fuel cartridge 2 is opened, and the gas fuel is supplied to the combustion chamber 8 through a fuel supply passage L1 formed in the upper wall 8b of the combustion chamber 8.

In addition, the supercharging device 3 is provided in the upper portion of the nailer body 1 covering the upper portion of the tool body 1, that is, the upper wall 8b of the combustion chamber 8 so as to supply compressed air for the supercharging operation to the combustion chamber 8. The supercharging device 3 includes a general reciprocation-type compressed air pump 25 and an electric motor 26 which drives the compressed air pump 25. When the electric motor 26 is driven, a piston 27 is driven to reciprocate in terms of a deceleration gear mechanism and a crank mechanism connected to a gear of a motor shaft (not shown), a predetermined pressure of compressed air is supplied to the combustion chamber 8 for the supercharging operation. The supercharging operation in which the compressed air is supplied to the combustion chamber 8 is carried out through the compressed air supply passage L2 formed in the upper wall 8b of the combustion chamber 8.

Trigger Switch

The trigger 28 is provided in the grip 4 integrally formed with the nailer body 1 receiving the driving mechanism a and the like. When the trigger 28 is operated, a switch 30 of the trigger 28 becomes an ON or OFF state so that an igniter 31 performs an ignition control of the spark plug (not shown). In addition, the igniter 31 performs a current supply control of a motor 12a of the stirrer 12 and the motor 26 of the supercharging device 3. The igniter 31 is electrically connected to a battery B received in a protruding end portion of the grip 4.

The gas nailer A has approximately the above-described structure. In addition, an operation of the gas nailer A will be described later in ‘Operation of Gas Nailer A’.

However, as described above, the pressure increase in the combustion chamber 8 during the supercharging operation causes the driving piston 10 to move downward, but the downward movement of the driving piston 10 interrupts the pressure increase in the combustion chamber 8, thereby reducing a power increase using the supercharging operation. In order to prevent such a reduction, the gas nailer A includes the locking device 15 which maintains the driving piston 10 at a predetermined position. Although the outline is partly described above, hereinafter, the structure will be described further in detail.

As described above, as shown in FIGS. 2 and 3, the driving piston 10 substantially includes the large-diameter piston portion 10a and the small-diameter piston portion 10b. Then, the outer periphery of the small-diameter piston portion 10b is surrounded by the annular locking device 15 having an annular width extending to a position corresponding to the lower inner wall of the annular wall 8a of the combustion chamber 8. Consequently, a pressure applied to the driving piston 10 in the combustion chamber 8 is applied to a head portion (see FIG. 2) of the small-diameter piston portion 10b having a small area exposed to the combustion chamber 8. The slightly upper portion of the outer periphery of the small-diameter piston portion 10b is locked to a pressing member 41 of the locking device 15 under a predetermined locking load. Accordingly, the driving piston 10 is immovably maintained at a predetermined position of the driving cylinder 7, that is, the initial position of the driving piston 10 as TDC when the pressure of the combustion chamber 8 is within a predetermined pressure.

That is, the pressure increase in the combustion chamber 8 occurs during the supercharging operation in which the compressed air is supplied to the combustion chamber 8. For instance, in this embodiment, when the gas fuel is supplied to the combustion chamber 8, but the compressed air is not supplied thereto, a locking load is applied to the driving piston 10 in order to maintain the driving piston 10 at the predetermined position even when the pressure increase in the combustion chamber 8, that is, the atmospheric pressure increase of +0.5 to 1 Kgf/cm2 or so occurs. (In addition, more specifically, since the driving piston 10 is slightly pressed during the supercharging operation, the position of the driving piston 10 due to the supercharging operation changes by Δd shown in FIG. 3(b) from an initial position of the driving piston 10, that is, the predetermined position shown in FIG. 3(a) to a position of the driving piston 10 after the supercharging operation shown in FIG. 3(b)).

The locking device 15 is formed into an annular shape, and includes the pressing member 41 for pressing the upper outer periphery of the small-diameter piston portion 10b. Additionally, the locking device 15 is formed by a main body portion 33 which is slidably fitted to the outer periphery of the small-diameter piston portion 10b in a sealed state through a seal member 34 and which is slidably fitted to the lower inner periphery of the annular wall 8a of the combustion chamber 8 in a sealed state through the seal member 34 and an annular extending portion 33a which extends downward from the outer periphery of the main body portion 33 so as to extend between the lower inner periphery of the annular wall 8a of the combustion chamber 8 and the upper outer periphery of the driving cylinder 7.

Then, when the inner periphery of the annular extending portion 33a is fitted to the upper outer periphery of the driving cylinder 7 in a substantially fixed state, the lower end of the annular extending portion 33a comes into contact with an annular end 37 of the upper outer periphery of the driving cylinder 7 under the fitted state, and a lower portion 38 of the main body portion 33 comes into contact with an upper end 7a of the driving cylinder 7. Accordingly, the locking device 15 is fitted and maintained at the upper portion of the driving cylinder 7 in a fixed state.

The pressing member 41 of the locking device 15 is configured as spherical members which are urged by springs 42 respectively inserted in a plurality, for instance, four holes 40 formed from the outer periphery to the inner periphery of the main body portion 33 of the annular locking device 15 in a radial shape and are arranged in a circumferential direction at the same interval there between. At this time, a locking load generated by a predetermined pressing action is applied to the small-diameter piston portion 10b in such a manner that each spring 42 urges the pressing member 41 configured as the spherical member inward, that is, toward the center of the driving piston 10. The locking load generated by the pressing action of the pressing member 41 can be adjusted by controlling a screw fastening degree of a screw 39.

Meanwhile, an annular concave groove 46 as a locking member of the pressing member 41 is formed in the outer periphery of the small-diameter piston portion 10b so as to surely maintain the locking state of the driving piston 10, the locking action preventing the downward movement of the driving piston 10.

Then, in the nail driving operation, when a downward moving force of the driving piston 10 in which the pressure of the combustion chamber 8 is applied to a pressure receiving portion of the upper surface (see FIG. 2) of the small-diameter piston portion 10b exceeds a maintaining force for maintaining the driving piston 10 by using the locking load of the locking device 15, that is, when the pressure increase in the combustion chamber 8 occurs when the combustion gas is expanded during combustion, as shown in FIG. 3(c), the pressing member 41 fitted into the annular concave groove 46 formed in the outer periphery of the small-diameter piston portion 10b is pushed outward while resisting the urging force of the spring 42, thereby releasing the locking action for locking the driving piston 10 using the locking device 15 and moving downward the driving piston 10.

Subsequently, the pressing force generated by the pressure of the expanded combustion gas is applied to both pressure receiving portions of the small-diameter piston portion 10b and the large-diameter piston portion 10a, thereby moving downward the driving piston 10. Accordingly, it is possible to carry out the nail driving operation using the driver 11 without any disturbance.

The return movement in which the driving piston 10 moves upward after the nail driving operation is carried out by a negative pressure generated by a volume decrease occurring when the gas within the driving cylinder 7 is cooled after the expanded combustion gas within the driving cylinder 7 is discharged to the outside through the exhaust port 14. Specifically, the large-diameter portion 10a formed in the front end of the outer periphery of the small-diameter piston portion 10b of the driving piston 10 moving upward by the negative pressure pushes outward and passes the pressing member 41 protruding from the inner periphery of the locking device 15 while resisting the urging force of the spring 42. Accordingly, the driving piston 10 is located at the predetermined initial position, that is, TDC. This action state is shown in FIG. 3(d).

In the first embodiment, since the locking load generated by the locking device 15 for maintaining the driving piston 10 at the predetermined position is set to a small value in accordance with a decrease in a substantial pressure receiving area of the driving piston 10, it is possible to sufficiently carry out the return movement in which the driving piston 10 moves upward even when the negative pressure within the driving cylinder 7 is, for instance, in the range of −0.2 to −0.3 kgf/cm2 or so.

Operation of Gas Nailer

It has been described about the driving piston maintaining mechanism for the gas nailer A according to the above-described embodiment, and the nail driving operation is carried out in the following procedures and actions. Next, the first embodiment will be described with reference to FIGS. 2 and 3.

First, the front end of the contact arm 13 of the gas nailer A presses the target object, and the contact arm 13 is relatively pressed upward while resisting the urging force of the spring 22.

When the contact arm 13 moves upward while resisting the urging force of the spring 22, the annular wall 8a of the combustion chamber 8 moves upward through the link portion 20 so that the combustion chamber 8 changes from the opened state to the closed state. After a slight time difference, when the actuator 23 of the gas fuel cartridge 2 is operated to move upward, the lockout bar 32 is operated to release a locking action between the trigger 28 and a cam member 29. Subsequently, an operation member is operated to push upward to turn on a switch (not shown) of a driving motor of the stirrer 12 and a switch (not shown) of a driving motor of the super charger 3.

When the contact arm 13 performs an initial operation for starting the gas nailer A, the gas injection port 24 of the gas fuel cartridge 2 is opened, and an amount of the gas fuel for performing the one-time nail driving operation is measured by a metering valve which is not clearly shown in the drawing and is supplied to the combustion chamber 8 through the fuel supply passage L1 formed in the upper wall 8b of the combustion chamber 8. At the same time, the stirrer 12 is driven to rotate and the compressed air for the supercharging operation is supplied to the combustion chamber 8 through the compressed air supply passage L2 formed in the upper wall 8b upon operating the pump of the supercharging device 3. Subsequently, the stirrer 12 stirs and mixes the air with the gas fuel so as to be uniform.

In the procedures described above, the driving piston 10 according to the first to third embodiments disposed inside the driving cylinder 7 is maintained by a predetermined locking load by using the locking device according to the first to third embodiments irrespective of the pressure increase in the combustion chamber 8 due to the supercharging operation so as to be immovably maintained at a predetermined position, that is, the initial position as TDC.

Subsequently, when the trigger 28 is manually pushed inward, the switch of the trigger 28 becomes an ON state and the spark plug (not shown) is ignited by the igniter, thereby burning the mixed fuel in the combustion chamber 8.

When the combustion pressure generated upon burning the mixed fuel is applied to the head portion of the driving piston 10, the locking action is released in which the driving piston 10 is locked by the locking device 15, and then the driving piston 10 moves downward. When the driving piston 10 moves downward, the front end of the driver 11 integrally fixed to the driving piston 10 moves downward along the injection port 18 disposed in the nose part 6. When the front end of the driver 11 moves downward along the injection port 18, the driver 11 hammers a head portion of the nail sent from the magazine portion 5 to the injection port 18 so that the nail is driven into a predetermined position of the target object.

Then, when the driving piston 10 moves downward to BDC, the front end of the driver 11 slightly protrude from the front end of the nose part 6 to start hammering the head portion of the nail, thereby surely performing the nail driving operation. When the driving piston 10 moves downward to BDC, the completely expanded exhaust gas is discharged from the exhaust port 14 formed on the lower side portion of the driving cylinder 7.

When the exhaust gas is discharged from the driving cylinder 7 to the outside, the gas in the driving cylinder 7 is cooled so as to decrease a volume thereof and to promote the occurrence of the negative pressure in the driving cylinder 7. When the negative pressure occurs in the driving cylinder 7, the driving piston 10 moves upward.

When the trigger 28 is releases before or after the above-described operation, allows the cam 29 is rotated in a clockwise direction by the trigger 28 so as to return to the initial position. At this time, the lockout bar 32 can move downward and the combustion chamber 8 becomes an opened state. That is, the connection plate 21 can move downward.

When the connection plate 21 moves downward, the annular wall 8a of the combustion chamber 8 moves downward so as to open the seal portion 19 which is in a sliding-contact with the annular wall 8a and the outer periphery of the upper wall 8b of the combustion chamber 8. Subsequently, air is introduced to the combustion chamber 8 through the opened seal portion 19. At the same time, the driving switch (not shown) of the stirrer 12 and the actuator 23 of the gas fuel cartridge 2 and the driving switch of the supercharging device 3 become an OFF state. Subsequently, the released trigger 28 is locked when the lockout bar 32 moves downward, thereby preventing an erroneous operation of the gas nailer A.

Incidentally, in the return movement in which the driving piston 10 moves to the upper portion of the driving cylinder 7, in order to ensure the smooth return movement, it is necessary to consider an influence of the locking load of the locking device 15 at a position around TDC. For this reason, upon using the locking device 15 described in the first embodiment, the locking force generated by the pressing action of the locking device 15 is set to a small value. Accordingly, the return movement of the driving piston 10 exceeds the locking force generated by the locking load of the locking device 15, that is, the return movement of the driving piston 10 caused by the negative pressure in the driving cylinder 7 pushes outward the pressing member 41 configured as the spherical member which is urged by the comparatively small urging force of the spring 22. Accordingly, it is possible to return the driving piston 10 to the predetermined position as TDC without any disturbance.

### Other Embodiments

Next, other embodiments of the gas nailer A will be described. The gas nailer A according to the other embodiments is substantially identical with that of the first embodiment except that the structure for maintaining the driving piston is modified. In the description, the same reference numerals are given to the same components of the first embodiment.

### Second Embodiment

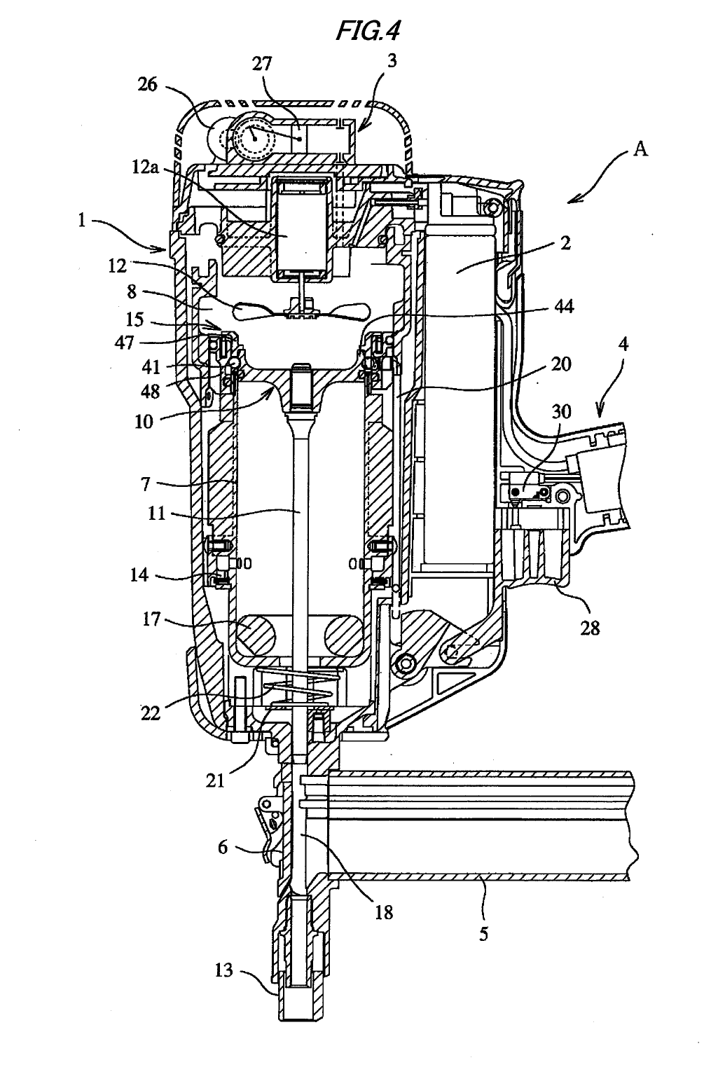

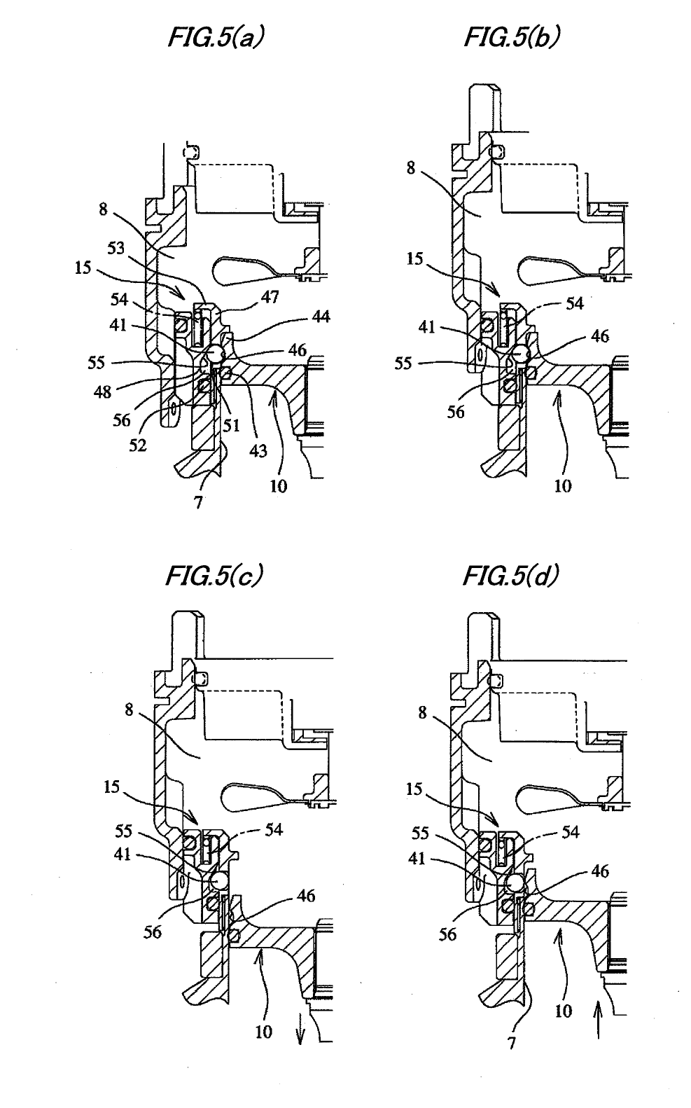

As shown in FIGS. 4 and 5, the driving piston 10 according to the second embodiment has a structure in which the outer periphery of the driving piston 10 slides on the inner wall of the driving cylinder 7 through a seal ring 43 and an annular protruding portion 44 is formed in the upper portion of the driving piston 10. The annular protruding portion 44 formed in the upper portion of the driving piston 10 protrudes from the upper portion of the driving cylinder 7 by a predetermined height when the driving piston 10 is located at TDC.

An annular concave groove 46 is formed in the outer periphery of the annular protruding portion 44 formed in the upper portion of the driving piston 10 so as to be used for the locking action carried out by the locking device 15. When the pressing member 41 as the spherical member of the locking device 15 is locked to the annular concave groove 46, the driving piston 10 is maintained at the predetermined position under the predetermined locking load.

That is, the driving piston 10 is immovably maintained at the predetermined position with respect to the predetermined pressure in the combustion chamber 8. The driving piston 10 is immovably maintained at the predetermined position with respect to at least the pressure increase in the combustion chamber 8 during the supercharging operation in which the compressed air is introduced into the combustion chamber 8, for instance, the atmospheric pressure increase of +0.5 kgf/cm2.

The locking device 15 includes an annular fixed portion 47 and an annular movable portion 48. The fixed portion 47 includes the inner periphery with a different diameter. The lower inner periphery having a slightly larger diameter is fitted to the upper outer periphery of the driving cylinder 7 in a substantially fixed state. The central inner periphery having a slightly smaller diameter is fitted to the upper outer periphery of the driving piston 10 so as to be movable in a sliding manner. Accordingly, the driving piston 10 can slides on the fixed portion 47 fixed to the upper outer periphery of the driving cylinder 7 through the upper outer periphery of the driving piston 10. In addition, the fixed portion 47 includes an opening hole 51 for maintaining the pressing member 41 as the spherical member.

The movable portion 48 includes the inner periphery fitted to the outer periphery of the fixed portion 47 through a seal member 52 so as to be movable in a sliding manner. The movable portion 48 is urged downward by a urging force of a spring 54 of which the upper end is supported to a collar 53 formed outward in the upper end of the fixed portion 47 and a pressure in the combustion chamber 8 applied to the upper end surface of the movable portion 48, and is configured to be movable in a sliding manner in parallel to a driving direction of the driving piston 10 is carried out. In addition, for this sliding action, the movable portion 48 includes a locking groove 56 having a slope surface 55 formed in the inner periphery and serves as locking means interlocked with a spherical member 58 of the fixed portion 47.

The locking action for locking the driving piston 10 using the locking device 15 is carried out in the following procedures. The locking groove 56 having the slope surface 55 formed in the inner periphery of the movable portion 48 is located at a position opposed to the spherical member 41 of the fixed portion 47. Subsequently, when the movable portion 48 moves in a sliding manner, that is, the movable portion 48 moves downward to the lower position as shown in FIGS. 5(a) and 5(b) by the urging force of the spring 54 and the pressure applied to the upper end surface, the slope surface 55 of the locking groove 56 presses the spherical member 41 rightward. Subsequently, the spherical member 41 is strongly pressed by the annular groove 55 formed in the outer periphery of the driving piston 10 so as to lock the driving piston 10.

The locked driving piston 10 is locked and maintained at the upper portion of the driving cylinder 7 so as not to move with respect to the predetermined pressure in the combustion chamber 8 in terms of a maintaining force obtained by the predetermined locking load. Specifically, the driving piston 10 is immovably maintained at the predetermined position, that is, the initial position as TDC even when the pressure increase occurs in the combustion chamber 8 during the supercharging operation in which the compressed air is introduced into the combustion chamber 8.

Then, when the pressure in the combustion chamber 8 exceeds the predetermined internal pressure, the movement force in which the pressure in the combustion chamber 8 is applied to the pressure receiving portion of the upper surface of the driving piston 10 so that the driving piston 10 moves downward exceeds the maintaining force for maintaining the driving piston 10 by using the locking load of the locking device 15. For instance, as shown in FIG. 5(c), when the pressure increase occurs when the combustion gas is expanded during combustion, the movement force for moving downward the driving piston 10 exceeds the maintaining force for maintaining the driving piston 10 by using the locking load of the locking device 15, thereby releasing the locking action.

That is, the spherical member 41 fitted to the annular concave groove 46 formed in the outer periphery of the driving piston 10 is pushed by the movement force for moving downward the driving piston 10 due to the pressure applied to the pressure receiving surface of the head portion of the driving piston 10. Subsequently, the movable portion 48 moves upward by the pressing force applied to the slope surface 55 of the spherical member 41 while resisting the urging force of the spring 54 and the pressure applied to the upper end surface of the movable portion 48 occurring during the supercharging operation as shown in FIGS. 5(b) to 5(c), thereby releasing the locking action by deviating the contact position between the spherical member 41 and the slope surface 55. Accordingly, since the driving piston 10 moves downward when the locking maintaining force of the locking device 15 is released, it is possible to carry out the nail driving operation using the driver 11 without any disturbance.

Incidentally, the return movement in which the driving piston 10 moves upward after the nail driving operation is carried out by a negative pressure generated by a volume decrease occurring when the gas within the driving cylinder 7 is cooled after the expanded combustion gas within the driving cylinder 7 is discharged to the outside. At this time, the locking device 15 is maintained in a state where the locking action is released by the negative pressure for returning the driving piston 10.

That is, as shown in FIG. 5(d), since the movable portion 48 of the locking device 15 moves upward by the occurrence of the negative pressure in the driving cylinder 7, for instance, the negative pressure in the range of −0.2 to −0.3 kgf/cm2 or so, it is possible to surely return the driving piston 10 to the predetermined upper position.

In this way, since the movable portion 48 is configured to be urged downward by the urging force and the supercharging pressure, it is possible to set the urging force of the spring 54 to a small value. In addition, since the urging force of the spring 54 become smaller as much as the negative pressure when the negative pressure occurs in the combustion chamber 8 by using the supercharging operation, a resistance of the return movement of the driving piston 10 becomes small.

Accordingly, it is possible to surely carry out the return movement.

### Third Embodiment

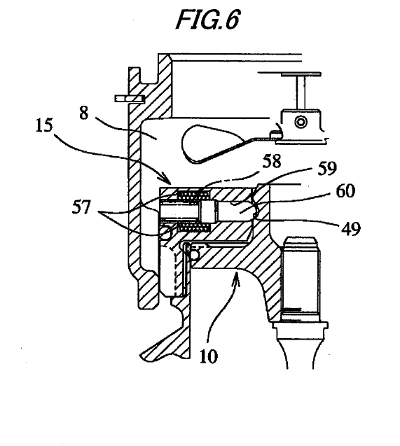

FIG. 6 shows the structure for maintaining the driving piston according to the third embodiment, which shows a modified example of the structure for maintaining the driving piston 10 according to the first embodiment. Additionally, the locking device 15 locks or unlocks the driving piston 10 by using a solenoid 57.

The locking device 15 is configured such that a pressing member 60 having a spherical front end and pressed by a spring 58 can slide along a hole portion 59 by using the solenoid 57. When the driving piston 10 is locked so as to maintain the driving piston 10 at the predetermined position, the solenoid 57 is demagnetized by turning off electric current to the solenoid 57 so that the front end of the pressing member 60 is pressed to a locking groove 49 of the driving piston 10 by the urging force of the spring 58.

In addition, when releasing the locking action for locking the driving piston 10, the solenoid 57 is magnetized by turning on electric current to the solenoid 57 so that the pressing member 60 is pushed back while resisting the urging force of the spring 58, thereby releasing the locking action carried out by the pressing member 60.

### Operation of Gas Nailer of Second and Third Embodiments

Although the gas nailer according to the second and third embodiments is operated in the same way as described above, the locking device 15 according to the second embodiment is used such that the sliding lock member moves upward by the negative pressure in the combustion chamber 8 and the driving cylinder 7 so that the slope surface 55 is separated from the spherical member 41 and the locking action for locking the spherical member 41 is released. Accordingly, the return movement of the driving piston 10 by the negative pressure in the combustion chamber 8 and the driving cylinder 7 is carried out without a direct influence of the locking device 15 and the driving piston 10 returns to the predetermined initial position as TDC without any disturbance.

In addition, the locking device 15 according to the third embodiment is used such that an operation pin returns while resisting the urging force of the spring by magnetizing the solenoid 57 so that the locking action for locking the driving piston 10 is released. Accordingly, the return movement of the driving piston 10 is smoothly carried out and the driving piston 10 returns to the predetermined initial position without any disturbance.

### Advantage of Embodiments of Invention

In the embodiments of the invention, it is possible to exhibit the following advantages with the above-described configuration.

In the first embodiment, since the driving piston 10 is formed by the large-diameter piston portion 10a and the small-diameter piston portion 10b and the pressure in the combustion chamber 8 is applied to the head portion of the small-diameter piston portion 10b, the pressure receiving area of the driving piston 10 decreases, the driving piston 10 is less influenced by the pressure increase in the combustion chamber 8 during the supercharging operation in which the compressed air is supplied to the combustion chamber 8, and the downward movement of the driving piston 10 can be prevented by the locking load of the comparatively small locking device 15. Accordingly, it is possible to miniaturize or simplify the locking device 15 and thus to reduce a cost. In addition, since the locking load is small, it is possible to carry out the return movement of the driving piston 10 without any disturbance by using the negative pressure after the nail driving operation.

Meanwhile, at the downward movement of the driving piston 10 during combustion, since the combustion pressure is applied to both head portions of the small-diameter piston portion 10b and the large-diameter piston portion 10a, it is possible to improve the nail driving force and to further improve operability of the nail driving operation due to the power increase resulted from the supercharging operation.

In the second embodiment, since the locking device 15 includes the movable portion 48 having the slope surface 55. At this time, since the urging force of the spring 54 presses downward the movable portion 48 and the slope surface 55 strongly presses the spherical member 45 toward the annular concave groove 46 formed in the outer periphery of the driving piston 10, it is possible to carry out the strong locking action for locking the driving piston 10 and thus to surely maintain the driving piston 10 by using the locking device 15 during the supercharging operation.

Further, since the movable portion 48 having the slope surface 55 relatively moves with respect to the fixed portion 47 by the occurrence of the negative pressure in the driving cylinder 7 upon returning the driving piston 10 and the locking action for locking the driving piston 10 using the locking device 15 is released by releasing the spherical member 41, it is possible to smoothly carry out the return movement in which the driving piston 10 moves upward without any disturbance. Accordingly, it is possible to improve operability of the nail driving operation using the gas nailer A due to the power increase resulted from the supercharging operation.

Furthermore, since the locking device 15 according to the first embodiment is modified to the locking device 15 according to the third embodiment such that the pressing member 60 is operated by the solenoid 57, it is possible to selectively perform the locking action or unlocking action of the driving piston 10 by using the locking device 15. Accordingly, the solenoid 57 is demagnetized by turning off electric current to the solenoid 57 so that the locking action is carried out by using the urging force of the locking device 15. As a result, it is possible to surely maintain the driving piston 10 at the predetermined position during the supercharging operation and to smoothly carry out the return movement in which the driving piston 10 returns by the negative pressure occurring after the nail driving operation because the locking action using the locking device 15 is released by turning on electric current to the solenoid 57 to magnetize the solenoid 57.

While the invention has been described with reference to the specific embodiments, it should be obvious to those skilled in the art that various changes and modification may be made without departing from the spirit and the scope of the invention.

This application claims a priority of Japanese Patent application No. 2006-047258 filed on Feb. 23, 2006, the entire contents of which are incorporated herein by reference.

### INDUSTRIAL APPLICABILITY

The present invention may be applied to a gas nailer as an internal combustion type tool for hammering a fastener such as a nail or a hammered screw.

1. A gas nailer comprising:
a driving cylinder;
a driving piston that slidably reciprocates in the driving cylinder;
a combustion chamber connected to an upper portion of the driving cylinder;
a gas fuel cartridge that supplies gas fuel into the combustion chamber;
a supercharging device that supplies compressed air to be supercharged into the combustion chamber; and
a locking device provided in the driving cylinder so as not to move the driving piston in accordance with a pressure increase in the combustion chamber during a supercharging.

2. The gas nailer according to claim 1, wherein the driving piston provided is operated in the driving cylinder by a combustion pressure generated when a mixture of gas fuel and air is burned in the combustion chamber, and a driver hammers a fastener by an action of the driving piston.

3. The gas nailer according to claim 1, wherein the locking device is locked to a small-diameter portion formed in the driving piston.

4. The gas nailer according to claim 1, wherein the locking device includes a movable portion provided in an upper portion of the driving cylinder and movable in parallel to a driving direction of the driving piston, and
wherein the locking device engages with or disengages from the driving piston by the movable portion.

5. The gas nailer according to claim 1, wherein the locking device is operable to perform a locking action or an unlocking action by magnetizing or demagnetizing a solenoid.
